(19) United States
(12) Patent Application Publication
(10) Pub. No.: US 2002/0012565 A1
(43) Pub. Date: Jan. 31, 2002

(54) Package for dispensing a flowable cosmetic composition and product

(76) Inventors: Jorge Sirna, Buenos Aires (AR); Daniel Omar Gonzalez, Buenos Aires (AR); Antonio Leon De La Barra Romero, Buenos Aires (AR); Roger Anthony Baines, Leeds (GB); Nicholas David Pattison, London (GB); Benjamin Phalan Oates, London (GB)

Correspondence Address: UNILEVER, PATENT DEPARTMENT, 45 RIVER ROAD, EDGEWATER, NJ, 07020, US

(21) Appl. No.: 09/556,272

(22) Filed: Apr. 24, 2000

(30) Foreign Application Priority Data
Apr. 23, 1999 (GB) 9909444.1

(51) Int. Cl. B43K 7/00

(52) U.S. Cl. 401/209

(57) ABSTRACT

Known packages for topically applying flowable cosmetic composition and especially antiperspirant or deodorant compositions include roll-ons in which the applicator for the composition is presented to the skin along the longitudinal axis of the container, with its distributing head pointing along that same axis.

In the present invention, when the invention package is emplouyed, its applicator is disposed along a second axis which is at an acute angle to the principal axis of the container, especially at a neck angle of from 12 to 30 degrees. Preferably the body of the container is frusto-conical, with an outward-facing sidewall aligning with the principal axis and an inward-facing sidewall aligning with the second axis.

Users find it easier to apply the formulations topically, such as in the armpits, from a package which has inclined principal and second axes.

The present invention relates to a package for dispensing a flowable cosmetic composition and particularly for dispensing a flowable antiperspirant or deodorant composition. The invention also relates to a product comprising such a package containing such a cosmetic composition, and particularly an antiperspirant or deodorant composition.

### TECHNICAL FIELD AND BACKGROUND ART

Flowable antiperspirant or deodorant compositions can comprise a number of forms, such as a liquid or a cream, or possibly a gel or micronized powder. Such flowable compositions are dispensed in a variety of packages. One common package comprises a roll-on which comprises a reasonably rigid tubular container having at one end a flat base enabling it to stand upright and an opposed second end having a mouth that acts as a seating for a ball which is able to rotate within the seating and dispense the composition topically. A more recent development has been the employment of a ball of larger diameter. The seating desirably has a sufficiently flexible lip to permit the ball to be inserted by being pressed into position. The ball is covered by a cap, which can itself have a flat top surface that enables the package to stand in an invert position. A roll-on usually dispenses a liquid composition, which in many instances is thickened to a sufficient extent to control its egress under gravity through the aperture defined by the ball and the inner surface of the mouth of the container.

In conventional roll-on packages, such as sold by Elida Faberge under their brand names Rexona or Dove, the ball is positioned directly above the base, so that the package is relatively stable when standing vertically, or if the cap covering the roll-ball has a flat top surface, when inverted. Likewise, the shape of the container for the cosmetic lotion typically resembles a cylinder, which can be round or may be oval in cross section, usually having symmetrical front and rear sidewalls. It is easy to stack and form into a multipack array for transportation and display.

The container of the package is grasped between the fingers and the palm of the hand and has a principal axis which in practice corresponds to the direction of its side-wall that abuts the fingers. The ball is placed in contact with the human skin, such as in the armpit for antiperspirants, and the composition is dispensed by rolling the ball across the skin. In conventional roll-ball packages, the mouth in which the ball is seated faces outwardly along the principal axis of the container, i.e. the plane of the mouth is orthogonal to the principal axis of the container and remains in that orientation when the container is rotated.

A package placed in the market by Beiersdorf in the second half of 1999 comprises a modification to the cylinder in which the rear sidewall is moulded to provide a groove in which a thumb can rest.

Personal experience with and observation of the positioning and movement of the human hand holding an applicator for a cosmetic composition for topical application, e.g. under armpits indicates that when the dispensing surface faces outwardly along the principal axis of the container, the topical application of cosmetic compositions can be awkward for the user, and that presentation of the applicator in a suitable direction can become more difficult as the user's wrist and elbow joints become less flexible, in that for example they can rotate through a narrower angle.

In the drawings of British Patent Application No 2272186, there is shown a parallel-sided tubular container having opposed ends, a first end being closed with a flat base and the second end being closed by a dimpled roll-ball in a seating. The container is bent approximately half along the tube, so that the roll-ball is no longer positioned vertically above the base, but faces at an angle to the tubular container and is displaced to one side. Such a displacement renders the package unstable, which is inconvenient, particularly during transportation of the package to a filling station, and subsequently during display of the package on shop shelves. Moreover, the shape is particularly inconvenient for stacking and for forming into arrays for multipack transportation and display.

In British Patent Application No 2304607, there is shown and described a two piece applicator for applying cosmetic or other lotions to the skin, of which one piece comprises a parallel-sided tubular reservoir for the lotion and the other piece an elongate lotion transfer member. The two pieces are brought together to form the applicator. The complete applicator manifests similar disadvantages of instability and impaired stacking capability to those-of GB 2272186 above.

In U.S. Pat. No. 4571106, there is described an applicator for sun tan lotion resembling a curved cow-horn to which a roll-ball has been fitted to one end. Such a device is unable to stand on its end, rendering it difficult to fill, and would occupy a disproportionate shelf space whilst on display.

Dispensers for lotions have been contemplated in other fields of activity using applicators other than a roll ball. Thus, for example, in GB1479480, there is described an applicator for a medical fluid comprising a sponge which is cranked and of reduced cross section relative to a parallel-sided tubular container. The design of roll-ball dispensers can present additional problems compared with sponge dispensers if the ball axis is cranked relative to the container. For example, the ball protrudes virtually its radius above its seating, whereas a sponge tends to protrude only a little, so that a cranked ball, together with a covering cap, tends to decrease package stability.

It is an object of the present invention to devise alternative roll-ball packaging which simultaneously is easier for a user to employ whilst retaining acceptable vertical stability.

### SUMMARY OF THE INVENTION

In the present invention, the roll-ball package for dispensing the antiperspirant or deodorant composition no longer has the axis along which the roll-ball faces coaxial with the principal axis of the container, but the roll-ball faces along a second axis that is inclined at an acute angle to the principal axis, and the centre of the roll-ball is located vertically above the first end of the container.

In practice, this means that according to the present invention there is provided a package suitable for dispensing a flowable cosmetic composition comprising:

(i) a container with opposite first and second ends, the first end being closed by a planar external surface that enables the package to stand upright, the second end defining a mouth which comprises a seating for a roll-ball; the container having a principle axis extending longitudinally and second axis orthogonal to the mouth, the second axis being acutely inclined to the principle axis;

(ii) a ball which is rotatably seated within the seating and is partially proud of the seating, the centre of the roll-ball being located vertically above the first end of the container; and

(iii) a cap seatable over the roll-ball.

The angle between the principal axis and the second axis is sometimes referred to as the neck angle.

By acutely angling the dispensing ball relative to the container, that is to say angling the principal axis to the second axis, the ergonomics of applying the composition are improved, making it easier for the user to apply the cosmetic composition, for example the application of an antiperspirant or deodorant composition in the armpit. However, by simultaneously positioning the roll-ball such that its centre is vertically above the base of the container, the package exhibits vertical stability.

One very convenient way to construct a package having acutely inclined principal and second axes employs a container having asymmetrical front and rear sidewalls.

According to certain preferred embodiments of the present invention, there is provided a package for topical application of a flowable cosmetic composition to human skin comprising:

(i) a container with opposite first and second ends, the first end being closed by a planar external surface that enables the package to stand upright, the second end defining a mouth which comprises a seating for a roll-ball, the container having a principle axis extending longitudinally and a secondary axis which is orthogonal to the mouth, which axes are inclined at an acute angle to each other and opposite front and rear sidewalls, one of the front and rear sidewalls being aligned with the principal axis and the other of the front and rear sidewalls being aligned with the secondary axis;

(ii) a ball which is rotatably seated within the seating and is partially proud of the seating, the centre of the roll-ball being located vertically above the first end of the container; and

(iii) a cap seatable over the roll-ball.

According to a second aspect of the present invention there is provided a product for topical application to human skin comprising a flowable cosmetic composition contained in an invention package.

The invention further provides a process for topically applying a cosmetic composition to human skin contained in a package according to present invention.

### DETAILED DESCRIPTION OF THE INVENTION

In essence, and at its broadest, the invention comprises acutely angling the dispensing roll-ball relative to the container so that when the container is held in the hand, the roll ball is facing along a second axis having a positive angle relative to the principal axis of the container whilst positioning the ball above the container base.

In some embodiments, this can be achieved by employing a container, for example a tubular container, having straight sides, in which the mouth is not transverse to both the parallel front and rear sidewalls, but its plane is inclined at an angle to the base.

Herein, unless the context demands other wise, the head points from rear to front.

However, it is preferable for the container to comprise, a body section and a head section meeting certain criteria. The body section has a sidewall aligned along the principal axis in the region of the package that is grasped by the user's hand, and the head section extends along the second axis and which terminates in the mouth which is orthogonal to the second axis. The combination provides a particularly comfortable package for application by a conventional user and a shape that is particularly well suited for presentation to armpits. This shape can also render it easier for topical application of a distributing surface onto the soles of one's feet, and especially for older persons who are less supple and bend less easily than in their youth.

Herein, in preferred embodiments of the invention, the container body has asymmetrical front and rear sidewalls, namely the two sidewalls are inclined at an acute angle to each other, preferably at an angle which is selected from the ranges given herein for the angle of inclination between the principal and second axes and particularly preferably the angles between the front and rear sidewalls and the principal and second axes are similar or the same. In many convenient embodiments, the two sidewalls, if extended above the container into the head section, would intersect within the roll-ball. Often, the front sidewall is upright, and substantially aligned with the principal axis, and the rear sidewall inclines backwardly and upwardly towards the front sidewall. In such embodiments, the second axis is desirably aligned substantially with the rear sidewall. Alignment does not demand that planes and axis be precisely parallel, but can deviate by up to several degrees, such as 5 degrees.

The employment of a sloping rear sidewall has the benefit of improving the stability of the package relative to a container which has parallel sided front and rear walls. Its centre of gravity is lowered because a greater proportion of the container contents is held towards its base, and it has a wider base than the average for a parallel sided container of similar height and volume. This also is of benefit in enabling a bigger roll-ball to be employed whilst ensuring that the centre of the ball remains above the base of the container, compared with a parallel sided container.

The head and body sections of the container can comprise together a single unit in which the container is moulded to provide the desired shape, or can alternatively comprise two mouldings which fit together in a fluid tight arrangement. Non-circular mouldings can desirably employ a snap-fit join and circular mouldings can additionally employ a screw fit join. The relative proportions of the two sections are limited by employing a sufficiently short head section that the centre of the roll-ball remains above the container base. The body section often constitutes from 60 to 90% of the total length of the body plus head sections, and particularly in the region of 70%.

The angle of inclination of the two sections to each other or of the mouth to the container comprises the neck angle, specified above. The neck angle is preferably at least 10 up to 40 degrees, particularly at least 12 degrees and not more 30 degrees, especially less than 30 degrees. Particularly favourable results have been achieved at an angle of inclination in the region of 20 degrees, such as from 18 to 25 degrees. In other embodiments, an angle of about 12 degrees is favoured. The most favoured range is from 12 to 25 degrees. The angle between the two sections of the container may be sharp or contoured. The choice of a relatively small angle between the two axes, such as from 12 to 25 degrees is of assistance in pointing the head of the package in a most desirable orientation for topical application in the axila.

By varying the neck angle and the relative lengths of the body and head of the container, the position of the centre of the roll-ball over the container base also varies. By choosing either a more acute angle (i.e. smaller) or a shorter head to body, the centre of the roll-ball is positioned more centrally within the container base.

Herein, the central area of the base is considered to be within half the radius from the centre of the base, and especially preferably within the central third of the radius from the centre of the base. It is especially desirable to select an angle of inclination of below 25 degrees and the body to comprise at least 65% of the combined body plus head, to enhance stability benefits.

The invention is applicable to packages in which the container has a first, closed end which is has a planar surface, enabling it to stand upright. The planar surface may be completely flat or comprise a flat rim and an inwardly domed central area. The base often has a diameter if round or minor diameter if oval of between 35 and 55 mm.

The invention is particularly applicable to packages in which the container is reasonably rigid. Alternatively, the container sidewall can be flexible enough for the user to aid passage of the composition around the roll-ball by squeezing.

The container is desirably either round or oval in cross section that is transverse to respectively the principal or second axes. The cross section may be constant along the container, but preferably the body of the container is frusto-conical, the cone having as indicated above either a round or oval cross section.

In some particularly preferred packages of the present invention, the outward facing (front) sidewall of the body, i.e. that part of the body which is in contact with the fingers of the hand in use, is aligned within 5 degrees of the principal axis and the inward facing (rear) sidewall, i.e. that part of the body which is in contact with the palm of the hand in use, is aligned within 5 degrees of the second axis. In such packages, the sides of the container align closely with respectively the principal axis of the container as it stands waiting to be used and the second axis along which the roll-ball faces, thereby assisting the user to face the ball towards the surface to which he or she wishes to apply the formulation topically. The user, if he desires, can rotate the container in his hand, so as to alter the contact angle with the body, allowing further flexibility in use.

In preferred embodiments, the container part of the package has the shape of an anvil, and particularly with an inclined head. An anvil shape enables the container to enjoy the benefits of its two opposed sidewalls (front and front) being aligned with the principal and second axes, respectively. At the junction between the head section and the body section, there is preferably a strengthening shoulder. The anvil shape is obtained by employing a rear sidewall that has a high waist, that is to say close to the head of the container. Below its waist, the rear sidewall extends forwardly and upwardly to provide an inclined surface for contact with the hand, and above the waist, the sidewall projects backwardly, often sharply, to create a shoulder. The head section comprising the roll-ball and its seating rests upon the shoulder. The angle of the sidewall to the vertical above the waist and forming the shoulder is often at least twice that fraction of the rear sidewall which is below the waist and which is gripped by the hand. The waisted shape of the sidewall locates the hand onto the container, provides a shoulder having a lower surface which can rest on the hand and directs the head in the desired direction. This not only provides a cue to the user, but also assists the comfort of using the container.

The shoulder in many embodiments extends to at or near a theoretically plane extending vertically upwards rear the first end (the base) of the container. Near indicates that the edge of the shoulder is commonly within d/5 of the theoretical plane, where d is the rear to front diameter of the container at its base. The presence of the shoulder can itself act as a counterbalance to the head extending by a similar distance beyond the theoretical plane at the back of the container. This improves the stability of the container. By allowing the head to extend both to the front and rear of the container, it is possible to employ the maximum size of roll-ball relative to diameter of the container, whilst at the same time providing a sidewall shaped to accommodate the hand.

In other and related embodiments in which the container adopts the shape of an anvil, the alignment of principal axis to the front and rear sidewalls is vice versa to that described above. The rear sidewall is similar waisted and the should similarly extends at or near the theoretical plane extending vertically above the base. In these embodiments the principal axis is aligned with the rear sidewall, and the second axis aligned with the front sidewall. This provides the user with at least some of the benefits that accrue when the second axis is aligned with the rear sidewall.

The container mouth provides a seating for the roll-ball fitting sufficiently tightly within the seating that it does not fall out but sufficiently loosely to permit it to rotate and allow passage of the composition as a surface layer on the ball. The regulation of the fit is often chosen inversely in conjunction with the viscosity of composition.

The seating for the roll-ball can conveniently comprise a stand-alone unit which is capable of fitting in a fluid-tight manner into the opening of the container, for example fitting within the sidewall of the head section extending along the line of the second axis. This is advantageous, because it permits a stand-alone roll-ball and seating unit that is used in conventional parallel sided roll-ball designs to be employed in the invention package.

The ball for a roll-on package can be spherical, but alternative shapes, such as oval ball are possible. The shape of the mouth is designed in conjunction with and matching that of the ball. The size of the ball is at the discretion of the package manufacturer. In many instances the diameter of the ball is chosen in the range of 20 mm to 50 mm. It is especially desirable to employ a ball having a diameter of from 30 to 45 mm, sometimes colloquially called a big ball. The ball preferably has a smooth exterior surface, so that it can roll smoothly across the skin surface and does not contain dimples in which residues of formulation can lodge, potentially drying out between applications and forming gritty particles.

The combination of ball and seating employed in the present invention can comprise any such combination that has been described or employed for roll-on packages in which the head is not angled to the container. Preferably, the ratio of ball diameter to container base diameter or minor diameter is in the range of from 1:1 to 1:1.5.

Advantageously, it is possible to employ a container having a head section with a sidewall that is aligned at an acute angle to the principal axis into which is fitted a unit comprising a ball located within a seating therefor, the ball having a larger than average diameter, e.g. from 30 mm to 45 mm so as to combine the sensory benefits of a large ball with the ergonomic advantages of an angled head. Such containers desirably have a sloping rear sidewall, and a roll-ball of similar diameter to the minor diameter of the base of the container.

The container is desirably made from a mouldable thermoplastic such as polyethylene or polypropylene, such as by blow moulding. Alternatively, it can be made from glass, and provided with a ball seating, normally made from a mouldable plastic that is snap or screw fitted into the opening of the glass container. The container often is dimensioned to hold between 20 and 120 mls of composition, and in many instances between 40 and 70 mls. Such a size is convenient to hold for topical application axially.

The closure and cap are most conveniently made from thermoplastic materials. The cap can if desired have flat exterior surface to enable the package to stand in an invert manner. The cap can also be provided on its inner surface with seal means, often by moulding the inner surface to form a profile, eg a raised ring that fits into the aperture in or around the closure or depresses the ball against the lower retaining lip of the seating to prevent leakage of the contents during storage.

The packages of the present invention can conveniently be employed for hitherto described liquid or cream, flowable gel or micronized powder antiperspirant or deodorant compositions which have used or contemplated for use in roll-on packages.

The invention also provides a product comprising a package according to the first aspect described hereinbefore, in which the container contains a fluid antiperspirant or deodorant composition that can flow or be squeezed through the aperture by application of normal hand pressure to a flexible side-walled container. Such a formulation is normally observable as a thickened liquid or a cream, and usually has a viscosity within the range of from 500 to 100000 mpas·s.

Viscosity measurements herein correspond to those made using a Brookfield™ RVT viscometer, No 2 spindle, at 20 rpm at 25° C.

The compositions normally comprise one or more of a) an antiperspirant active and/or b) a deodorant active, a) normally being selected in the range of 0.5 to 60%, often from 5 to 40% and b) normally being selected in the range of from 0.1 to 90% and often up to 60%. The antiperspirant active a) is often an astringent aluminium zirconium or mixed aluminium zirconium salt or a complex thereof, such an aluminium chlorohydrate or a zirconium aluminium complex or an activated chlorohydrate or complex. The deodorant active can comprise a monohydric C1-C4 alcohol such as ethanol or isopropanol, in which case it is often present at a concentration of at least 10% especially at least 20%, and can function at least in part as a carrier as well as deodorant. The deodorant can additionally or alternatively comprise bactericides such as chlorinated aromatics or biguanides, often at a concentration of not more than 5% and particularly up to 2%.

Formulations employed herein commonly comprise from 10 to 95% of a carrier and especially from 30 to 90%. The carrier can comprise a single phase, be it hydrophobic or hydrophilic, or can comprise a mixture of such phases, normally present as an emulsion. Suitable hydrophobic carriers can include volatile silicone oils such as cyclomethicones (especially tetramer, pentamer and/or hexamer) or corresponding volatile linear methicones, and/or non-volatile hydrocarbon oils. Other suitable carriers include aliphatic ethers or esters containing a C8 to C30 group.

Hydrophilic carriers include water, aliphatic monohydric alcohols, glycols or tri or polyhydric alcohols.

The increase in viscosity of the fluid formulation is normally obtained by incorporation of one or more structurants, gellants or thickeners in an amount selected from 0.1 to 10% particularly from 0.2 to 5% and in many embodiments from 0.3 to 2% to increase the viscosity to the formulation to within the desired range for a cream. Suitable structurants include synthetic or natural carbon-based waxes, e.g. beeswax, hydroxystearic acid or castor wax or silicone waxes, or silicone elastomers. Suitable gellants include fatty alcohols, certain amide derivatives of tricarboxylic acids, dibenzylidene sorbitol and N-acyl amino acid derivatives, e.g. n-lauroyl-L-glutamic acid dibutylamide. Suitable thickeners can include gums, starches cellulose derivatives and inorganic thickeners such as clays or silica. Some viscosity increase can also be achieved by selection of carrier constituents of higher viscosity or by incorporation of particulate actives.

The formulation can also contain one or more conventional minor additives, such as in an amount of up to 10%, such as fragrance, talc, or humectant (glycerol or sorbitol).

Except in operative or comparative examples, all numbers herein indicating amounts or ratios of materials, such as limits of ranges are to be understood as modified by about, unless expressly stated otherwise.

Having described the invention in general terms, a specific embodiment will now be described more fully by way of example only with reference to the accompanying drawings in which:

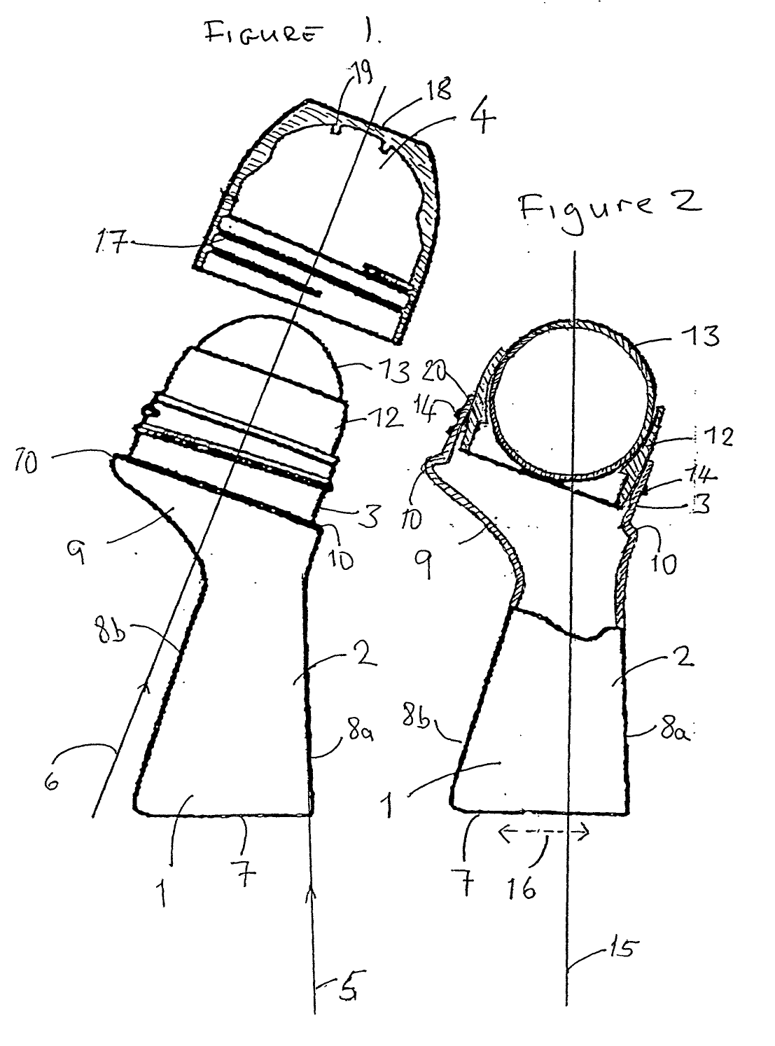

FIG. 1 represents a side view of a container and roll-ball dispenser with an exploded and part cross sectioned cap;

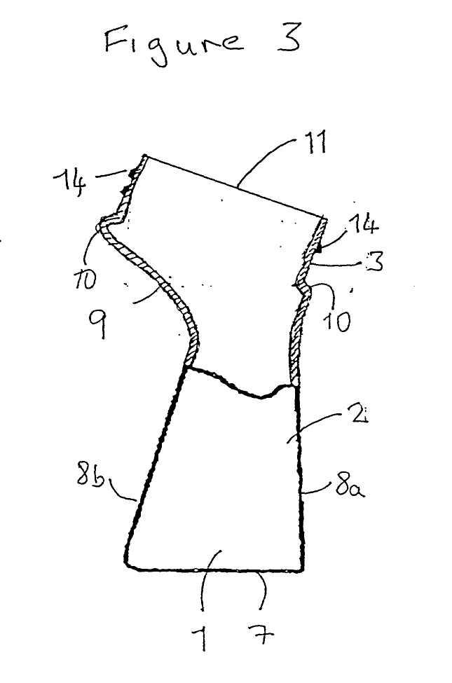

FIG. 2 represents a part cross sectioned view of the container and roll ball dispenser of FIG. 1.

FIG. 3 represents the container of FIG. 2 without the roll-ball dispenser.

In the Figures, the package comprises a one-piece moulded container 1 having a body section 2 and a head section 3 and a cap 4. The body section 2 is aligned along principal axis 5 and the head section 3 is aligned along second axis 6.

The body section 2 has a flat base 7, and a sidewall which on its outward facing (front) sidewall 8a is approximately parallel with the principal axis 5 and on its inward facing (rear) sidewall 8b is nearly parallel with the second axis 6, differing by an angle of about 5 degrees. The body section 2 has an projection 9 rendering it anvil-shaped, and has a shoulder 10 to which the head section 3 is integrally joined.

The side wall of the head section 3 extends parallel with the second axis 6 and is provided with external screw threads 14. The head section 3 terminates in an opening 11 in which is fitted in fluid-tight connection a seating 12 for a loosely fitting ball 13 of diameter approximately 35 mm. The seating 12 extends along the second axis 6. The line 15 passing through the centre of the roll-ball 13 intersects the base 7 of the container within a central area 16.

The cap 4 is provided with internal screw threading 17, a flat top surface 18 and a raised ring 19.

The body 2 is filled with an antiperspirant or deodorant or other cosmetic composition through opening 11 and the seating 12 and ball 13 inserted to act as a closure. For topically applying the composition, for example to the armpit, in one orientation, the container body 2 is grasped in the user's hand with the ball pointing upwardly, sidewall 8a or 8b abutting the palm of the hand and the other of sidewall 8b or 8a abutting the fingers and thumb. In alternative orientations, the container body 2 can be rotated, such as to face the head section 3 away from the arm or even inverted. The container is inverted or shaken to contact the composition with the surface of the ball 13 that is within the container head 3, and the container is then presented to and rolled across the armpit or other area to be contacted, thereby causing the composition to be carried on the surface of the ball 13 through a narrow aperture between the ball 13 and the seating 12 and onto the skin.

The container is closed by screwing the cap onto the head section 3, the raised ring 19 contacting the ball 13 and urging it against the lower lip 20 of the ball seating.

In a variation, an alternative container accords with FIGS. 1 to 3, except that the plane of opening 11 has been rotated to bring it parallel with base 7, and in this variation the principal axis of the container aligns with rear sidewall 8b and the second axis aligns with front sidewall 8a.

### EXAMPLES 1 TO 9

These Examples describe fluid formulations which are suitable for employment in a package according to FIGS. 1 to 3.

TABLE

| Example No | 1 | 2 | 3 | 4 | 5 | 6 | 7 | 8 | 9 |
|---|---|---|---|---|---|---|---|---|---|
| Constituent | Per cent by weight | | | | | | | | |
| Ethanol | | 30 | | 60 | | | | 30 | |
| Isopropanol | 30 | | 30 | | 30 | 60 | 30 | | |
| Hydroxypropyl- | 0.7 | 0.7 | 0.7 | 0.7 | 0.7 | 0.7 | 0.7 | 0.7 | |
| cellulose | | | | | | | | | |
| ACH | | 4 | 4 | | | | 20 | | |
| AZH | | | | | | | | 20 | |
| AZAG | | | | | | | | | 20 |
| PHMB | | | | 0.2 | 0.2 | | | | |
| Triclosan | | | | | | 0.1 | | | |
| Suspending | | | | | | | | | 3 |
| Agent | | | | | | | | | |
| Propylene | | | | | | | | | 1 |
| Carbonate | | | | | | | | | |
| Talc | | | | | | | | | 6 |
| Water + minors | to | to | To | to | to | to | to | to | |
| | 100 | 100 | 100 | 100 | 100 | 100 | 100 | 100 | |
| Cyclomethicone + | | | | | | | | | to |
| minors | | | | | | | | | 100 |

ACH represents aluminium chlorohydrate, AZH represents aluminium zirconium pentachlorohydrate, AZAG represents aluminium zirconium tetrachlorohydrex glycine complex, and PHMB represents poly(hexamethylenebiguanide).

1. A package suitable for dispensing a flowable cosmetic composition comprising:
(i) a container with opposite first and second ends, the first end being closed by a planar external surface that enables the package to stand upright, the second end defining a mouth which comprises a seating for a roll-ball; the container having a principle axis extending longitudinally and second axis orthogonal to the mouth, the second axis being acutely inclined to the principle axis;
(ii) a ball which is rotatably seated within the seating and is partially proud of the seating, the centre of the roll-ball being located vertically above the first end of the container; and
(iii) a cap seatable over the roll-ball.

2. A package for topical application of a flowable cosmetic composition to human skin comprising:
(i) a container with opposite first and second ends, the first end being closed by a planar external surface that enables the package to stand upright, the second end defining a mouth which comprises a seating for a roll-ball, the container having a principle axis extending longitudinally and a secondary axis which is orthogonal to the mouth, which axes are inclined at an acute angle to each other and opposite front and rear sidewalls, one of the front and rear sidewalls being aligned with the principal axis and the other of the front and rear sidewalls being aligned with the secondary axis;
(ii) a ball which is rotatably seated within the seating and is partially proud of the seating, the centre of the roll-ball being located vertically above the first end of the container; and
(iii) a cap seatable over the roll-ball.

3. A package according to either preceding claim wherein the neck angle comprising the angle between the second axis and the principal axis is from 10 to 40 degrees, and preferably from 12 to 30 degrees.

3. A package according to claim 2 wherein the neck angle is from 12 to 25 degrees.

4. A package according to any preceding claim characterised in that the container has a rear sidewall and a back sidewall which are inclined to each other at an angle from 10 to 40 degrees, and preferably from 12 to 30 degrees.

5. A package according to claim 4 characterised in that the rear sidewall is aligned with the second axis.

6. A package according to claim 4 characterised in that the rear sidewall is aligned with the principal axis.

7. A package according to any of claims 4 to 6 characterised in that the rear sidewall is high waisted.

8. A package according to claim 7 characterised in that the rear sidewall has a shoulder above its waist which extends to at or near a theoretical plane which extends vertically above the circumference of the first end.

9. A package according to claim 8 characterised in that the shoulder and the head both extend outside the theoretical plane ending vertically above the circumference of the first end, the one to the rear and the other to the front.

10. A package according to any preceding claim wherein the ball is spherical.

11. A package according to any preceding claim wherein the ball has a diameter of between 1 and 5 cm, and preferably between 3 and 4 cm.

12. A package according to any preceding claim in which the container is circular or oval in cross section transverse to respectively the principal or second axis.

13. A package according to any preceding claim in which the centre of the roll-ball is positioned above a central area of the first end of the container.

14. A package according to any preceding claim wherein the container comprises a one-piece moulding.

15. A package according to any of claims 1 to 13 wherein the container comprises two mouldings in fluid-tight connection.

16. A package according to claim 15 wherein the two mouldings are screw or snap fitted.

17. A package according to claim 15 or 16 wherein one moulding comprises a container and the second moulding comprises a seating for a ball, which seating fits within the opening of the container.

18. A package according to any preceding claim wherein the container comprises a body section which has an outward-facing (front) sidewall that aligns within 5 degrees of the principal axis and an inward facing (rear) sidewall that aligns within 5 degrees of the second axis.

19. A product for topical application to human skin comprising a flowable cosmetic composition contained in a package according to any preceding claim.

20. A product according to claim 19 wherein the composition comprises an antiperspirant or deodorant composition.

21. A product for topical application to human skin substantially as described herein with respect to any one of Examples 1-9.
